(19) United States
(12) Patent Application Publication
(10) Pub. No.: US 2026/0163702 A1
(43) Pub. Date: Jun. 11, 2026

(54) METHOD AND APPARATUS FOR MULTIPLEXING HARQ-ACK FEEDBACK ON PUSCH

(71) Applicant: LENOVO (BEIJING) LIMITED, Beijing (CN)

(72) Inventor: Haipeng Lei, Beijing (CN)

(21) Appl. No.: 18/706,595

(22) PCT Filed: Nov. 5, 2021
(86) PCT No.: PCT/CN2021/129021

§ 371 Date: May 1, 2024

(51) Int. Cl. H04L 5/00

(52) U.S. Cl. CPC H04L 5/0055; H04L 5/0044

(57) ABSTRACT

Embodiments of the present disclosure relate to multiplexing HARQ-ACK feedback on a PUSCH. According to some embodiments of the disclosure, a UE may receive a first set of PDSCHs associated with a first service and a second set of group-common PDSCHs associated with a second service. The UE may receive a DCI format scheduling a PUSCH, wherein the DCI format may include a first DAI associated with HARQ-ACK feedback to be multiplexed on the PUSCH. The UE may generate a HARQ-ACK codebook comprising a first HARQ-ACK sub-codebook for the first set of PDSCHs and a second HARQ-ACK sub-codebook for the second set of PDSCHs. The UE may multiplex the HARQ-ACK codebook on the PUSCH.

### TECHNICAL FIELD

Embodiments of the present disclosure generally relate to wireless communication technology, and more particularly to multiplexing hybrid automatic repeat request acknowledgement (HARQ-ACK) feedback on a physical uplink shared channel (PUSCH).

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, a user equipment (UE) may monitor a physical downlink control channel (PDCCH) in one or more search spaces. The PDCCH may carry downlink control information (DCI), which may schedule uplink channels, such as a physical uplink shared channel (PUSCH), or downlink channels, such as a physical downlink shared channel (PDSCH). A UE may transmit hybrid automatic repeat request acknowledgement (HARQ-ACK) feedback (e.g., included in a HARQ-ACK codebook) corresponding to PDSCH transmissions through a physical uplink control channel (PUCCH) or a physical uplink shared channel (PUSCH).

There is a need for handling HARQ-ACK feedback multiplexing on a PUSCH in a wireless communication system.

### SUMMARY

Some embodiments of the present disclosure provide a user equipment (UE). The UE may include: a transceiver; and a processor coupled to the transceiver. The processor may be configured to: receive a first set of physical downlink shared channels (PDSCHs) associated with a first service and a second set of group-common PDSCHs associated with a second service, wherein the second service is a multicast service; receive a downlink control information (DCI) format scheduling a physical uplink shared channel (PUSCH), wherein the DCI format comprises a first downlink assignment index (DAI) associated with hybrid automatic repeat request acknowledgement (HARQ-ACK) feedback to be multiplexed on the PUSCH; generate a HARQ-ACK codebook comprising a first HARQ-ACK sub-codebook for the first set of PDSCHs and a second HARQ-ACK sub-codebook for the second set of PDSCHs; and multiplex the HARQ-ACK codebook on the PUSCH.

Some embodiments of the present disclosure provide a base station (BS). The BS may include: a transceiver; and a processor coupled to the transceiver. The processor may be configured to: transmit, to a user equipment (UE), a first set of physical downlink shared channels (PDSCHs) associated with a first service; transmit, to a group of UEs including the UE, a second set of PDSCHs associated with a second service, wherein the second service is a multicast service; transmit, to the UE, a downlink control information (DCI) format scheduling a physical uplink shared channel (PUSCH), wherein the DCI format comprises a first downlink assignment index (DAI) associated with hybrid automatic repeat request acknowledgement (HARQ-ACK) feedback to be multiplexed on the PUSCH; receive, from the UE, a HARQ-ACK codebook on the PUSCH, wherein the HARQ-ACK codebook comprises a first HARQ-ACK sub-codebook for the first set of PDSCHs and a second HARQ-ACK sub-codebook for the second set of PDSCHs.

Some embodiments of the present disclosure provide a method for wireless communication performed by a user equipment (UE). The method may include: receiving a first set of physical downlink shared channels (PDSCHs) associated with a first service and a second set of group-common PDSCHs associated with a second service, wherein the second service is a multicast service; receiving a downlink control information (DCI) format scheduling a physical uplink shared channel (PUSCH), wherein the DCI format comprises a first downlink assignment index (DAI) associated with hybrid automatic repeat request acknowledgement (HARQ-ACK) feedback to be multiplexed on the PUSCH; generating a HARQ-ACK codebook comprising a first HARQ-ACK sub-codebook for the first set of PDSCHs and a second HARQ-ACK sub-codebook for the second set of PDSCHs; and multiplexing the HARQ-ACK codebook on the PUSCH.

Some embodiments of the present disclosure provide a method for wireless communication performed by a base station (BS). The method may include: transmitting, to a user equipment (UE), a first set of physical downlink shared channels (PDSCHs) associated with a first service; transmitting, to a group of UEs including the UE, a second set of PDSCHs associated with a second service, wherein the second service is a multicast service; transmitting, to the UE, a downlink control information (DCI) format scheduling a physical uplink shared channel (PUSCH), wherein the DCI format comprises a first downlink assignment index (DAI) associated with hybrid automatic repeat request acknowledgement (HARQ-ACK) feedback to be multiplexed on the PUSCH; receiving, from the UE, a HARQ-ACK codebook on the PUSCH, wherein the HARQ-ACK codebook comprises a first HARQ-ACK sub-codebook for the first set of PDSCHs and a second HARQ-ACK sub-codebook for the second set of PDSCHs.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a schematic diagram of HARQ-ACK codebook determination in accordance with some embodiments of the present disclosure;

FIG. 3 illustrates a schematic diagram of HARQ-ACK codebook determination in accordance with some embodiments of the present disclosure;

FIG. 4 illustrates a flow chart of an exemplary procedure of wireless communications in accordance with some embodiments of the present disclosure;

FIG. 5 illustrates a flow chart of an exemplary procedure of wireless communications in accordance with some embodiments of the present disclosure; and

FIG. 6 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

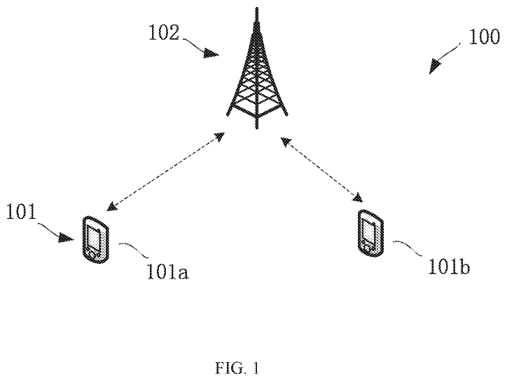

FIG. 1 illustrates a schematic diagram of a wireless communication system 100 in accordance with some embodiments of the present disclosure.

As shown in FIG. 1, a wireless communication system 100 may include some UEs 101 (e.g., UE 101a and UE 101b) and a base station (e.g., BS 102). Although a specific number of UEs 101 and BS 102 are depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

In some embodiments of the present disclosure, the wireless communication system 100 may support multicast and broadcast services (MBSs). For example, one or more UEs (e.g., UE 101a and UE 101b) may be grouped as an MBS group to receive a MBS(s) (e.g., an MBS PDSCH) from a BS (e.g., BS 102).

A group-common radio network temporary identifier (RNTI) (e.g., group-RNTI (G-RNTI)) is introduced for an MBS so that a UE can differentiate a DCI scheduling a group-common PDSCH carrying an MBS service (e.g., an MBS PDSCH) from a DCI scheduling UE-specific PDSCH carrying a unicast service. For example, the cyclic redundancy check (CRC) of the DCI scheduling the unicast PDSCH may be scrambled by a UE-specific RNTI (e.g., cell-RNTI (C-RNTI)) and the scheduled unicast PDSCH may also be scrambled by the UE-specific RNTI. The CRC of the DCI scheduling the group-common PDSCH may be scrambled by a G-RNTI and the scheduled group-common PDSCH carrying the MBS may also be scrambled by the G-RNTI. When a UE supports multiple MBS services, each service may be configured with a G-RNTI specific to the service. In other words, from a UE's perspective, the G-RNTIs can be used to differentiate the multiple MBS services.

The HARQ-ACK feedback from UEs corresponding to a downlink multicast transmission is essential for the multicast services in order to satisfy the QoS requirement, e.g., reliability.

In some embodiments of the present disclosure, when UE is configured with parameters such as the pdsch-HARQ-ACK-Codebook, pdsch-HARQ-ACK-CodebookList, etc. for ACK/NACK-based feedback for multicast, the parameters may be applied to all G-RNTIs (all multicast services) configured to UE.

In some embodiments of the present disclosure, HARQ-ACK feedback for unicast and HARQ-ACK feedback for a multicast service(s) may be multiplexed in the same PUCCH resource. In these embodiments, separate HARQ-ACK sub-codebooks may be generated for the unicast service and the multicast service(s), and then concatenated into a HARQ-ACK codebook (e.g., Type-2 HARQ-ACK codebook or dynamic HARQ-ACK codebook as specified in 3GPP specifications).

In some embodiments of the present disclosure, HARQ-ACK feedback for a plurality of multicast services may be multiplexed in the same PUCCH resource. In the above embodiments, separate HARQ-ACK sub-codebooks may be generated for the plurality of multicast services, and then concatenated into a HARQ-ACK codebook (e.g., Type-2 HARQ-ACK codebook or dynamic HARQ-ACK codebook as specified in 3GPP specifications).

In some embodiments, for HARQ-ACK codebook concatenation to be multiplexed in the same PUCCH resource, the HARQ-ACK sub-codebook for unicast may precede the HARQ-ACK sub-codebook(s) for the multicast service(s). When a UE supports and is configured with a plurality of G-RNTIs (e.g., for a plurality of multicast services), for HARQ-ACK codebook construction, the downlink assignment indicator (DAI) may be separately counted per G-RNTI. HARQ-ACK codebook may be constructed by concatenating the HARQ-ACK sub-codebooks for the plurality of multicast services according to a predefined order (e.g., an ascending order of the corresponding G-RNTI values).

For example, assuming a UE supports two MBS services, when HARQ-ACK feedback for the two MBS services is to be transmitted in the same slot and the two MBS services are of the same priority, the UE may multiplex the HARQ-ACK information bits for the two MBS services into one codebook, and then transmit it in a PUCCH. For instance, firstly, separate sub-codebooks may be generated for the two MBS services, where each sub-codebook includes HARQ-ACK information bits only for the corresponding MBS service arranged based on the order of the DAIs corresponding to each sub-codebook. Then, the two sub-codebooks may be concatenated in the ascending order of the G-RNTI values associated with the two MBS services. The concatenated sub-codebooks may be regarded as the final HARQ-ACK codebook and transmitted in the PUCCH in the indicated slot.

In some embodiments, a UE may not support simultaneous PUCCH and PUSCH transmissions in a PUCCH cell group. In some examples, when a PUCCH and a PUSCH are to be transmitted in the same slot, the UE may multiplex the uplink control information (UCI), including for example, HARQ-ACK feedback, on the PUSCH and drop the PUCCH. To avoid any misunderstanding between the UE and the BS on the number of HARQ-ACK information bits, when HARQ-ACK feedback multiplexes on a PUSCH, the DCI format for scheduling the PUSCH may include a field of UL downlink assignment index (DAI) to help the UE to determine the number of HARQ-ACK information bits. For example, the value of UL DAI may indicate the number of {serving cell, PDCCH monitoring occasion} pairs in which PDSCH transmission(s) associated with PDCCH or PDCCH indicating semi-persistent scheduling (SPS) PDSCH release is present. In some examples, when the a code block group (CBG)-based transmission is configured for PDSCH transmission, the DCI format for scheduling the PUSCH may include two fields of UL DAI, one for transport block (TB)-based HARQ-ACK sub-codebook and another for CBG-based HARQ-ACK sub-codebook.

As mentioned above, a wireless communication system may support MBSs. In some embodiments, when HARQ-ACK feedback for unicast PDSCHs and HARQ-ACK feedback for multicast PDSCHs carrying one or more multicast services overlap with a PUSCH, a UE may multiplex the HARQ-ACK feedback for unicast and the one or more multicasts on the PUSCH and drop the PUCCH.

When HARQ-ACK feedback is to be multiplexed on a PUSCH, the DCI scheduling the PUSCH may include a UL DAI field for determining the number of HARQ-ACK information bits as well as the number of resource elements (REs) required for multiplexing the HARQ-ACK feedback. Since separate DAIs are used for unicast and multicast and for different multicast services, multiple HARQ-ACK sub-codebooks may be generated for the unicast and multicast services with HARQ-ACK feedback to be multiplexed on the PUSCH. For example, a first sub-codebook including HARQ-ACK information bits for a unicast PDSCH(s), a second sub-codebook including HARQ-ACK information bits for PDSCHs carrying multicast #1, and a third sub-codebook including HARQ-ACK information bits for PDSCHs carrying multicast #2, . . . , and the last sub-codebook including HARQ-ACK information bits for PDSCHs carrying multicast #n with the largest G-RNTI value of the supported multiple multicast services may be generated, wherein the sub-codebooks for the multicast services may be ordered in an ascending order of the respective G-RNTI values. In this scenario, when the UL grant for scheduling the PUSCH only include a UL DAI field for the unicast PDSCHs (e.g., one UL DAI field when CBG-based transmission is not configured or two UL DAI fields when CBG-based transmission is configured), an error case may happen.

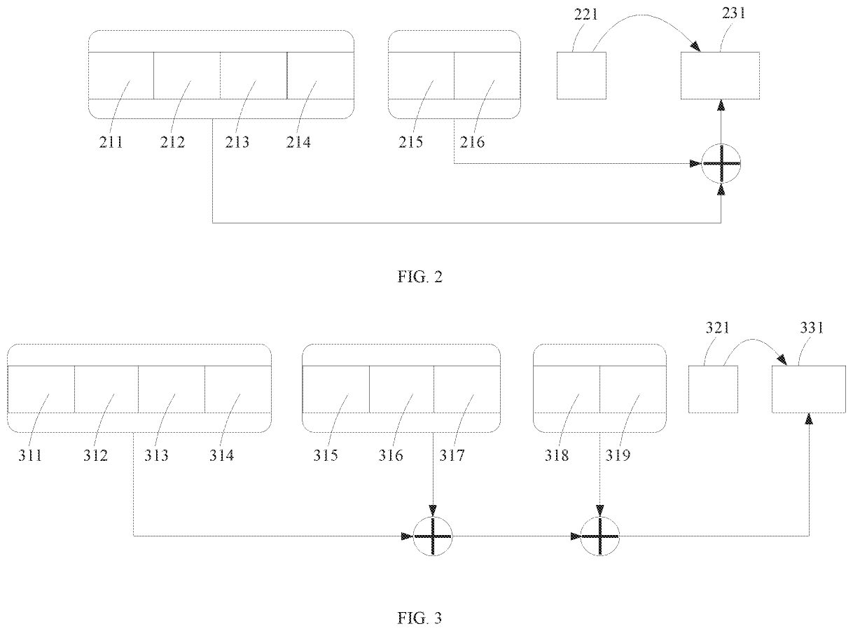

For example, referring to FIG. 2, it is assumed that two multicast services, for example, multicast service #1A and multicast service #2A, are supported by a UE. A BS may transmit, to a UE, four DCI formats 211-214 with DL DAIs equal to 1, 2, 3, and 4, respectively, to schedule four PDSCHs (e.g., PDSCHs #1-#4) associated with multicast service #1A, and two DCI formats 215 and 216 with DL DAIs equal to 1 and 2, respectively, to schedule two PDSCHs (e.g., PDSCHs #5 and #6) associated with multicast service #2A.

Assuming that HARQ-ACK feedback for PDSCHs #1-#6 is indicated to be transmitted in the same slot, the UE may generate HARQ-ACK sub-codebook #1A for multicast service #1A and HARQ-ACK sub-codebook #2A for multicast service #2A. HARQ-ACK sub-codebook #1A may include HARQ-ACK information bits for PDSCHs #1-#4, and HARQ-ACK sub-codebook #2A may include HARQ-ACK information bits for PDSCHs #5 and #6. Assuming that the G-RNTI value of multicast service #1A is smaller than that of multicast service #2A, HARQ-ACK sub-codebook #1A may be placed in front of HARQ-ACK sub-codebook #2A in the final HARQ-ACK codebook.

Assuming that the UE further receives DCI format 221 for scheduling PUSCH 231 in the same slot as the HARQ-ACK feedback, the UE may multiplex the HARQ-ACK codebook on PUSCH 231. However, since the UL DAI field in the DCI format 221 cannot indicate the number of HARQ-ACK information bits for the two separate sub-codebooks (e.g., HARQ-ACK sub-codebooks #1A and #2A) for the multicast services, the UE may generate and transmit a wrong HARQ-ACK codebook when either the last DCI (e.g., DCI format 214) scheduling PDSCH for multicast service #1A or the last DCI (e.g., DCI format 216) scheduling PDSCH for multicast service #2A is missed by UE, and determine a wrong number of REs on the PUSCH. Such misunderstanding between the UE and a BS would cause the retransmission of unnecessary PDSCHs by the BS, and thus degrade the DL performance.

Furthermore, when the HARQ-ACK feedback for PDSCHs carrying a unicast service is to be transmitted in the same slot with the HARQ-ACK feedback for PDSCHs carrying one or more MBS services and a PUSCH, similar error case may happen.

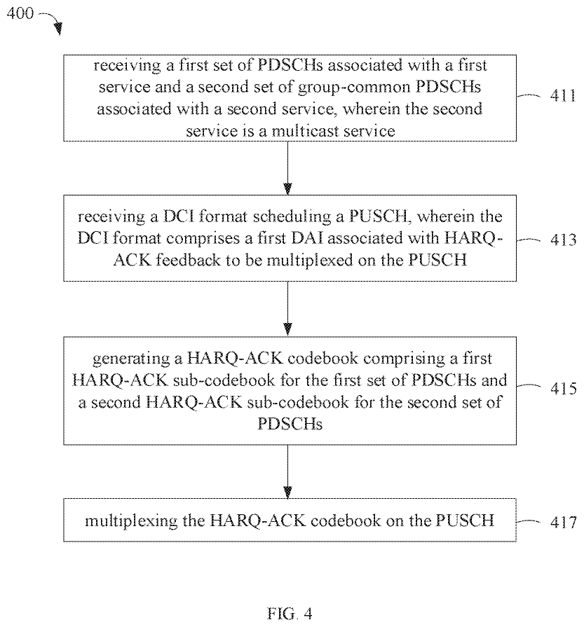

For example, referring to FIG. 3, a BS may transmit, to a UE, four DCI formats 311-314 with DL DAIs equal to 1, 2, 3, and 4, respectively, to schedule four PDSCHs (e.g., PDSCHs #1′-#4′) associated with the unicast service, three DCI formats 315-317 with DL DAIs equal to 1, 2, and 3, respectively, to schedule three PDSCHs (e.g., PDSCHs #5′-#7′) associated with multicast service #1A′, and two DCI formats 318 and 319 with DL DAIs equal to 1 and 2, respectively, to schedule two PDSCHs (e.g., PDSCHs #8′and #9′) associated with multicast service #2A′.

Assuming that HARQ-ACK feedback for the nine PDSCHs is indicated to be transmitted in the same slot, the UE may multiplex the HARQ-ACK feedback for the nine PDSCHs in the same HARQ-ACK codebook. For example, the UE may generate a unicast HARQ-ACK sub-codebook, HARQ-ACK sub-codebook #1A′ for multicast service #1A′ and HARQ-ACK sub-codebook #2A′ for multicast service #2A′. Unicast HARQ-ACK sub-codebook may include HARQ-ACK information bits for PDSCHs #1′-#4′, HARQ-ACK sub-codebook #1A′ may include HARQ-ACK information bits for PDSCHs #5′-#7′, and HARQ-ACK sub-codebook #2A′ may include HARQ-ACK information bits for PDSCHs #8′and #9′. Assuming that the G-RNTI value of multicast service #1A′ is smaller than that of multicast service #2A′, unicast HARQ-ACK sub-codebook may be placed at the beginning of the HARQ-ACK codebook, and then followed by HARQ-ACK sub-codebook #1A′ and HARQ-ACK sub-codebook #2A′ sequentially.

Assuming that the UE further receives DCI format 321 for scheduling PUSCH 331 in the same slot as the HARQ-ACK feedback, the UE may multiplex the HARQ-ACK codebook on PUSCH 331. However, since the UL DAI field in the DCI format 321 cannot indicate the number of HARQ-ACK information bits for the sub-codebooks of the multicast services (e.g., HARQ-ACK sub-codebooks #1A′ and #2A′), the UE may generate and transmit a wrong HARQ-ACK codebook when either the last DCI (e.g., DCI format 317) scheduling the PDSCH for multicast service #1A′ or the last DCI (e.g., DCI format 319) scheduling the PDSCH for multicast service #2A′ is missed by UE, and determine a wrong number of REs on the PUSCH. Such misunderstanding between the UE and a BS would cause the retransmission of unnecessary PDSCHs by the BS, and thus degrade the DL performance.

Embodiments of the present disclosure provide solutions for multiplexing HARQ-ACK feedback on a PUSCH. For example, solutions for indicating the UL DAIs for the unicast HARQ-ACK sub-codebook and at least one multicast HARQ-ACK sub-codebooks are proposed. For example, solutions for determining a HARQ-ACK codebook when HARQ-ACK feedback for at least one MBS service and a unicast service is to be multiplexed on a PUSCH are proposed. For example, solutions for determining a HARQ-ACK codebook when HARQ-ACK feedback for at least one MBS service is to be multiplexed on a PUSCH are proposed. These solutions can solve the HARQ-ACK codebook misunderstanding between a UE and a BS. More details on the embodiments of the present disclosure will be illustrated in the following text in combination with the appended drawings.

In some embodiments of the present disclosure, the DCI format scheduling a PUSCH may indicate the total number of HARQ-ACK information bits to be multiplexed on the PUSCH. For example, the UL-DAI field on the DCI format may indicate the total number of HARQ-ACK information bits for a unicast service and at least one multicast service. However, a problem lies in this solution is that the number of bits of the UL-DAI field (e.g., 2 bits) may not be enough to indicate the sum of the HARQ-ACK information bits to be multiplexed on the PUSCH.

In some embodiments of the present disclosure, the DCI format may indicate respective UL DAIs for the unicast service and at least one multicast service with HARQ-ACK feedback to be multiplexed on the scheduled PUSCH. However, this solution may have the following drawbacks: (1) the UE cannot determine the payload size of the UL grant; (2) too much overhead may be caused, especially when the UE is configured with the CBG-based transmission.

Embodiments of the present disclosure further provide enhanced solutions for multiplexing HARQ-ACK feedback on a PUSCH.

For a UE supporting a plurality of MBS services, RRC signaling may be used to configure a plurality of G-RNTI values with each G-RNTI corresponding to a respective multicast service and a plurality of priority values with each priority value corresponding to a respective multicast service. In response to the reception of the RRC signaling, the UE can determine the maximum number of HARQ-ACK sub-codebooks for multicast services with each sub-codebook corresponding to a respective multicast service based on the maximum number of multicast services with the same priority. For example, the UE can derive the maximum number of HARQ-ACK sub-codebooks for multicast services with priority 0 and the maximum number of HARQ-ACK sub-codebooks for multicast services with priority 1. Since, in some embodiments, multicast services with different priority values may be not supported to be multiplexed in the same HARQ-ACK codebook, based on the derived maximum number of HARQ-ACK sub-codebooks for multicast services with priority 0 or 1, the UE can generate the HARQ-ACK codebook according to the maximum number of HARQ-ACK sub-codebooks for priority 0 or 1.

In some embodiments of the present disclosure, the UL DAI field in the DCI format for scheduling a PUSCH may correspond to the HARQ-ACK sub-codebook placed in the front of the HARQ-ACK codebook to be multiplexed on the PUSCH.

In some embodiments, HARQ-ACK feedback for a PDSCH(s) of a unicast service and HARQ-ACK feedback for a multicast PDSCH(s) of at least one multicast service may be multiplexed on the scheduled PUSCH. The DCI format for scheduling PUSCH may indicate a DAI corresponding to the unicast service since the HARQ-ACK sub-codebook for the unicast PDSCHs is generally placed in front of all HARQ-ACK sub-codebook for the multicast PDSCHs.

For example, referring to FIG. 3, in which HARQ-ACK feedback for unicast PDSCHs is to be multiplexed with HARQ-ACK feedback for multicast PDSCHs of two multicast service on the same PUSCH, DCI format 321 scheduling PUSCH 331 may include a UL DAI corresponding to the HARQ-ACK sub-codebook for unicast PDSCHs.

When CBG-based transmission is not configured for the unicast PDSCHs, a single UL DAI corresponding to the unicast PDSCHs may be indicated in the DCI format. When CBG-based transmission is configured for the unicast PDSCHs, two UL DAIs, which respectively correspond to a TB-based HARQ-ACK sub-codebook for unicast PDSCHs and a CBG-based HARQ-ACK sub-codebook for unicast PDSCHs, may be indicated in the DCI format.

In some embodiments, no HARQ-ACK feedback for unicast PDSCHs may be multiplexed on the PUSCH and only HARQ-ACK feedback for at least one multicast service is to be multiplexed on the PUSCH. The DCI format for scheduling PUSCH may indicate a UL DAI corresponding to a specific multicast service of the at least one multicast service.

For example, when the at least one multicast service includes only one multicast service, the DAI in the DCI format scheduling the PUSCH may correspond to the HARQ-ACK codebook for the only one multicast service. That is, the UE determines the HARQ-ACK codebook for the only one multicast service based on the DAI. For example, when the at least one multicast service includes two or more multicast services, the specific multicast service may be the one with the corresponding HARQ-ACK sub-codebook placed in front of all other HARQ-ACK sub-codebook(s) in the HARQ-ACK codebook to be multiplexed on the PUSCH. For instance, the specific multicast service may be the one with the lowest G-RNTI value among the at least one multicast service.

For example, referring back to FIG. 2, in which no HARQ-ACK feedback for unicast PDSCHs is to be multiplexed with HARQ-ACK feedback for multicast PDSCHs of two multicast service on the same PUSCH, DCI format 221 scheduling PUSCH 231 may include a UL DAI corresponding to the HARQ-ACK sub-codebook for a multicast service. For example, assuming that HARQ-ACK sub-codebook #1A precedes HARQ-ACK sub-codebook #2A (e.g., the G-RNTI value of multicast service #1A is smaller than that of multicast service #2A), the UL DAI in DCI format 321 may correspond to HARQ-ACK sub-codebook #1A.

When CBG-based transmission is not configured, a single UL DAI corresponding to a multicast service may be indicated in the DCI format. The UL DAI may be applied to the specific multicast service, e.g., the multicast service with the lowest G-RNTI value among the at least one multicast service. When CBG-based transmission is configured for the unicast PDSCHs, two UL DAIs may be indicated in the DCI format. The two UL DAIs may be respectively applied to two multicast services, which may be the multicast services with the corresponding HARQ-ACK sub-codebooks placed in the first and second in the HARQ-ACK codebook to be multiplexed on the PUSCH. For example, the two UL DAIs may correspond to the multicast services with the lowest and the second lowest G-RNTI values among the at least one multicast service.

For a given multicast service with HARQ-ACK feedback to be multiplexed on the PUSCH, when the UL DAI in the DCI format scheduling the PUSCH corresponds to this multicast service, the corresponding HARQ-ACK sub-codebook size may be determined based on the value of the UL DAI. Otherwise, when UL DAI in the DCI format scheduling the PUSCH does not correspond to this multicast service, various methods may be employed to determine the HARQ-ACK sub-codebook size for the given multicast service.

For example, in some embodiments, the HARQ-ACK sub-codebook size may be determined based on a RRC configured size, for example, 1, 2, 3, 4, 5, 6, 7, 8, or other values. When the number of generated HARQ-ACK information bits for the multicast service (prior to padding) is smaller than the configured sub-codebook size, a padding bit(s) (e.g., NACK bit(s)) may be added (e.g., appended) to the HARQ-ACK sub-codebook such that the sub-codebook size for the multicast service is equal to the configured size. The above method is hereinafter referred to as “Option 1.”

In some embodiments, the HARQ-ACK sub-codebook size may be determined based on a set of candidate HARQ-ACK sub-codebook sizes. For example, HARQ-ACK feedback quantification may be employed to align the number of generated HARQ-ACK information bits for the multicast service (prior to padding) to a value in a set of candidate HARQ-ACK sub-codebook sizes. The set of candidate HARQ-ACK sub-codebook sizes for a multicast service may be configured by RRC signaling or predefined in a standard(s). Examples of the set of potential values may include {2, 4, 6, 8, 10, 12, etc.} or {4, 8, 12, etc.}. This method is hereinafter referred to as “Option 2.”

A UE may determine the HARQ-ACK sub-codebook size for the multicast service based on the received PDSCH transmissions for the multicast service, and may select a minimum value which is equal to or greater than the determined size from the set of candidate sizes as the final HARQ-ACK sub-codebook size for the multicast service. When the number of the generated HARQ-ACK information bits for the multicast service prior to padding is smaller than the final HARQ-ACK sub-codebook size, a padding bit(s) (e.g., NACK bit(s)) may be added (e.g., appended) to the HARQ-ACK sub-codebook such that the sub-codebook size for the multicast service is equal to the final HARQ-ACK sub-codebook size.

In some examples, different multicast services may share the same set of potential values for HARQ-ACK sub-codebook size. In some examples, different multicast services may be configured with respective sets of potential values for HARQ-ACK sub-codebook size. For example, two different multicast services may be associated with different sets of potential values.

The BS may take the candidate values into consideration when perform DL scheduling. For example, when a multicast service is associated with a set of HARQ-ACK sub-codebook sizes {4, 8, 12, etc.}, the BS may not schedule 5 DCIs which schedules PDSCHs for the multicast service with HARQ-ACK feedback to be multiplexed on the PUSCH, since the UE may generate a HARQ-ACK sub-codebook size of 4 even when the last transmitted DCI for the multicast service is missed by the UE.

In some embodiments, HARQ-ACK bundling among HARQ-ACK information bits of the HARQ-ACK sub-codebook for the multicast service may be performed. For example, the HARQ-ACK information bits of HARQ-ACK sub-codebook for the multicast service may be bundled to a predetermined number of bits. The bundling operation may include a logical AND operation. This method is hereinafter referred to as “Option 3.”

In some examples, RRC signaling may be used to configure a bundling size of N. For example, every N consecutive bits of the HARQ-ACK sub-codebook may be bundled to one bit. For example, N may be configured as 2, 4, or other values. In some example, N may be predefined in a standard(s).

In some examples, RRC signaling may be used to configure the number of bits of M after the bundling operation. For example, every [O/M] consecutive bits of the HARQ-ACK sub-codebook may be bundled to one bit, wherein O is the number of bits in the HARQ-ACK sub-codebook before the bundling operation. For example, M may be configured as 1, 2, 3, 4, or other values. In some example, M may be predefined in a standard(s).

In some embodiments, when the UL DAI in the DCI format scheduling the PUSCH corresponds to a multicast service (e.g., multicast service #A) of the at least one multicast service with HARQ-ACK feedback to be multiplexed on the scheduled PUSCH, the HARQ-ACK sub-codebook size for multicast service #A may be determined based on the UL DAI. The HARQ-ACK sub-codebook size for the remaining multicast service(s) (e.g., multicast service #B) among the at least one multicast service may also be determined based on the UL DAI. The above method is hereinafter referred to as “Option 4.”

When the DCI format includes two UL DAIs for two multicast services (e.g., multicast services #A and #C), the HARQ-ACK sub-codebook size for multicast service #B may be determined based on the two UL DAIs. For example, the HARQ-ACK sub-codebook size for multicast service #B may be determined based on based on one of the two UL DAIs, for example, the smaller one or the larger one.

When the number of generated HARQ-ACK information bits for multicast service #B prior to padding is smaller than the size determined based on the UL DAI corresponding to multicast service #A, a padding bit(s) (e.g., NACK bit(s)) may be added (e.g., appended) to the HARQ-ACK sub-codebook for multicast service #B such that the sub-codebook size for multicast service #B is equal to the size determined based on the UL DAI. Otherwise, when the number of generated HARQ-ACK information bits for multicast service #B prior to padding is larger than the size determined based on the UL DAI, truncation or bundling operation may be performed on the HARQ-ACK information bits to align with the determined size, or the HARQ-ACK information bits may be remained as they are. The bundling operation may be performed in a similar manner as described above with respect to Option 3.

In some embodiments of the present disclosure, an extra or dedicated UL DAI field for multicast may be included in the DCI format for scheduling the PUSCH.

In some embodiments, the DCI format scheduling a PUSCH may include a UL DAI field (denoted as “DAI #1”) corresponds to a unicast service and a UL DAI field (denoted as “DAI #2”) corresponds to a specific multicast service among at least one multicast service with HARQ-ACK feedback to be multiplexed on the PUSCH.

In some examples, DAI #1 may always be reserved for a unicast service. In other words, even when no HARQ-ACK feedback for unicast PDSCHs is to be multiplexed on the scheduled PUSCH, DAI #1 may not be reused for a multicast service. In this scenario, the value of DAI #1 may be set to indicate that no HARQ-ACK feedback for unicast PDSCHs is to be multiplexed on the scheduled PUSCH (e.g., DAI #1=“00”). This is beneficial when, for example, a UE deems that no HARQ-ACK feedback for a unicast PDSCH(s) is to be multiplexed on the scheduled PUSCH due to the miss of the DCI format(s) scheduling the unicast PDSCH(s), the UE can still generate the correct HARQ-ACK sub-codebook for the unicast service and would not consider that DAI #1 is (re)used for a multicast service.

The specific multicast service corresponding to DAI #2 may be the one with the largest or the smallest HARQ-ACK sub-codebook size among the HARQ-ACK sub-codebook(s) for the at least one multicast service with HARQ-ACK feedback to be multiplexed on the PUSCH.

For example, DAI #1 may correspond to the HARQ-ACK sub-codebook for the unicast service and DAI #2 may correspond to the HARQ-ACK sub-codebook with the largest or the smallest sub-codebook size among the HARQ-ACK sub-codebooks for the at least one multicast service. For example, DAI #1 may indicate the number of {serving cell, PDCCH monitoring occasion}-pair(s) in which unicast PDSCH transmission(s) associated with PDCCH or PDCCH indicating unicast SPS PDSCH release is present. For instance, DAI #1 may indicate the largest DL DAI for the unicast sub-codebook.

In some examples, DAI #2 may indicate the maximum number of {serving cell, PDCCH monitoring occasion}-pair(s) in which PDSCH transmission(s) associated with PDCCH or PDCCH indicating SPS PDSCH release is present among the at least one multicast service. For instance, DAI #2 may indicate the largest DL DAI for the at least one multicast sub-codebook.

In some examples, DAI #2 may indicate the minimum number of {serving cell, PDCCH monitoring occasion}-pair(s) in which PDSCH transmission(s) associated with PDCCH or PDCCH indicating SPS PDSCH release is present among the at least one multicast service. For instance, DAI #2 may indicate the smallest DL DAI for the at least one multicast sub-codebook.

Since DL DAI is counted separately for each sub-codebook, each multicast sub-codebook of the at least one multicast sub-codebook may have a corresponding DL DAI for calculating the corresponding multicast sub-codebook size and ordering the HARQ-ACK information bits in the corresponding multicast sub-codebook. The size(s) of the at least one multicast sub-codebook for the at least one multicast service may be generated based on DAI #2.

For example, when DAI #2 indicates the largest DL DAI among the multiple HARQ-ACK sub-codebooks, the UE may determine the largest sub-codebook size for the at least one multicast service based on DAI #2 and generate the HARQ-ACK sub-codebooks for the at least one multicast service based on the largest sub-codebook size. For example, when the number of generated HARQ-ACK information bits for a multicast service (prior to padding) is smaller than the largest sub-codebook size, a padding bit(s) (e.g., NACK bit(s)) may be added (e.g., appended) to the HARQ-ACK sub-codebook for the multicast service to align with the largest sub-codebook size.

For example, referring to FIG. 3, in which HARQ-ACK feedback for unicast PDSCHs is to be multiplexed with HARQ-ACK feedback for multicast PDSCHs of two multicast service on the same PUSCH, DCI format 321 may indicate two UL DAIs (e.g., DAI #1A and DAI #2A). DAI #1A may indicate 4 since the HARQ-ACK feedback for the four unicast PDSCHs (e.g., PDSCHs #1′-#4′) is to be multiplexed on PUSCH 331. DAI #2A may indicate 3 since there are a maximum of three multicast PDSCHS (e.g., PDSCHs #5′-#7′) of a multicast service with corresponding HARQ-ACK feedback to be multiplexed on PUSCH 331.

The UE may generate a unicast HARQ-ACK sub-codebook based on the value of DAI #1A (e.g., 4). For example, assuming that each unicast PDSCH corresponds to a single bit of HARQ-ACK information, the unicast HARQ-ACK sub-codebook may include 4 bits. The UE may generate HARQ-ACK sub-codebook #1A′ for multicast service #1A′ and HARQ-ACK sub-codebook #2A′ for multicast service #2A′ based on the value of DAI #2A (e.g., 3). For example, assuming that each multicast PDSCH corresponds to a single bit of HARQ-ACK information, HARQ-ACK sub-codebook #1A′ and HARQ-ACK sub-codebook #2A′ may include 3 bits. At least one padding bit may be added to HARQ-ACK sub-codebook #2A′ to align with the size of 3 bits since the UE may at most generate two HARQ-ACK information bits corresponding to the two PDSCHs (e.g., PDSCHs #8′and #9′) of multicast service #2A′.

For example, when DAI #2 indicates the smallest DL DAI among the multiple HARQ-ACK sub-codebooks, the UE may determine the smallest sub-codebook size for the at least one multicast service based on DAI #2 and generate the HARQ-ACK sub-codebooks for the at least one multicast service based on the smallest sub-codebook size. For example, when the number of generated HARQ-ACK information bits for a multicast service (prior to padding) is smaller than the smallest sub-codebook size, a padding bit(s) (e.g., NACK bit(s)) may be added (e.g., appended) to the HARQ-ACK sub-codebook for the multicast service to align with the smallest sub-codebook size.

For example, referring to FIG. 3, in which HARQ-ACK feedback for unicast PDSCHs is to be multiplexed with HARQ-ACK feedback for multicast PDSCHs of two multicast service on the same PUSCH, DCI format 321 may include two UL DAIs (e.g., DAI #1A′ and DAI #2A′). DAI #1A′ may indicate 4 since the HARQ-ACK feedback for the four unicast PDSCHs (e.g., PDSCHs #1′-#4′) is to be multiplexed on PUSCH 331. DAI #2A′ may indicate 2 since there are a minimum of two multicast PDSCHS (e.g., PDSCHs #8′-#9′) of a multicast service with corresponding HARQ-ACK feedback to be multiplexed on PUSCH 331.

The UE may generate a unicast HARQ-ACK sub-codebook based on the value of DAI #1A′ (e.g., 4). For example, assuming that each unicast PDSCH corresponds to a single bit of HARQ-ACK information, the unicast HARQ-ACK sub-codebook may include 4 bits. The UE may generate HARQ-ACK sub-codebook #1A′ for multicast service #1A′ and HARQ-ACK sub-codebook #2A′ for multicast service #2A′ based on the value of DAI #2A′ (e.g., 2). For example, assuming that each multicast PDSCH corresponds to a single bit of HARQ-ACK information, HARQ-ACK sub-codebook #1A′ may include 3 bits and HARQ-ACK sub-codebook #2A′ may include 2 bits when the UE receives all DCI formats scheduling PDSCHs #5′-#9′.

In some examples, when no HARQ-ACK feedback for unicast PDSCHs is to be multiplexed on the scheduled PUSCH, DAI #1 and DAI #2 may both be used for a multicast service.

For example, DAI #1 may correspond to the HARQ-ACK sub-codebook with the largest sub-codebook size among the HARQ-ACK sub-codebooks for the at least one multicast service, and DAI #2 may correspond to the HARQ-ACK sub-codebook with the smallest sub-codebook size among the HARQ-ACK sub-codebooks for the at least one multicast service. As an alternative, DAI #1 may correspond to the smallest multicast sub-codebook size and DAI #2 may correspond to the largest multicast sub-codebook size.

For instance, DAI #1 may indicate the maximum number of {serving cell, PDCCH monitoring occasion}-pair(s) in which PDSCH transmission(s) associated with PDCCH or PDCCH indicating SPS PDSCH release is present among the at least one multicast service. For example, DAI #1 may indicate the largest DL DAI among the at least one multicast sub-codebook. DAI #2 may indicate the minimum number of {serving cell, PDCCH monitoring occasion}-pair(s) in which PDSCH transmission(s) associated with PDCCH or PDCCH indicating SPS PDSCH release is present among the at least one multicast service. For example, DAI #2 may indicate the smallest DL DAI among the at least one multicast sub-codebook. As an alternative, DAI #1 may indicate the smallest DL DAI among the at least one multicast sub-codebook and DAI #2 may indicate the largest DL DAI among the at least one multicast sub-codebook.

The size(s) of at least one multicast sub-codebook for the at least one multicast service may be generated based on DAI #1 and DAI #2. For example, the UE may determine the largest sub-codebook size and the smallest sub-codebook size for the at least one multicast service based on DAI #1 and DAI #2, respectively. The UE may generate the HARQ-ACK sub-codebooks for the at least one multicast service based on the largest sub-codebook size and the smallest sub-codebook size.

For example, when the number of generated HARQ-ACK information bits for a multicast service (prior to padding) is smaller than the smallest sub-codebook size, a padding bit(s) (e.g., NACK bit(s)) may be added (e.g., appended) to the HARQ-ACK sub-codebook for the multicast service to align with the smallest sub-codebook size. When the number of generated HARQ-ACK information bits for a multicast service (prior to padding) is larger than the smallest sub-codebook size and smaller than the largest sub-codebook size, a padding bit(s) (e.g., NACK bit(s)) may be added (e.g., appended) to the HARQ-ACK sub-codebook for the multicast service to align with the largest sub-codebook size.

For example, referring back to FIG. 2, in which no HARQ-ACK feedback for unicast PDSCHs is to be multiplexed with HARQ-ACK feedback for multicast PDSCHs of two multicast service on the same PUSCH, DCI format 221 may include two UL DAIs (e.g., DAI #1B and DAI #2B).

DAI #1B may indicate 4 since there are a maximum of four multicast PDSCHS (e.g., PDSCHs #1-#4) of a multicast service with corresponding HARQ-ACK feedback to be multiplexed on PUSCH 231. DAI #2B may indicate 2 since there are a minimum of two multicast PDSCHS (e.g., PDSCHs #5 and #6) of a multicast service with corresponding HARQ-ACK feedback to be multiplexed on PUSCH 231. The UE may generate the HARQ-ACK sub-codebook #1A and HARQ-ACK sub-codebook #2A based on the values of DAI #1B and DAI #2B.

For example, DAI #1 may correspond to the HARQ-ACK sub-codebook with the largest sub-codebook size among the HARQ-ACK sub-codebooks for the at least one multicast service, and DAI #2 may correspond to the HARQ-ACK sub-codebook with the second largest sub-codebook size among the HARQ-ACK sub-codebooks for the at least one multicast service. As an alternative, DAI #1 may correspond to the second largest multicast sub-codebook size and DAI #2 may correspond to the largest multicast sub-codebook size.

For instance, DAI #1 may indicate the maximum number of {serving cell, PDCCH monitoring occasion}-pair(s) in which PDSCH transmission(s) associated with PDCCH or PDCCH indicating SPS PDSCH release is present among the at least one multicast service. For example, DAI #1 may indicate the largest DL DAI among the at least one multicast sub-codebook. DAI #2 may indicate the second largest number of {serving cell, PDCCH monitoring occasion}-pair(s) in which PDSCH transmission(s) associated with PDCCH or PDCCH indicating SPS PDSCH release is present among the at least one multicast service. For example, DAI #2 may indicate the second largest DL DAI among the at least one multicast sub-codebook. As an alternative, DAI #1 may indicate the second largest DL DAI among the at least one multicast sub-codebook and DAI #2 may indicate the largest DL DAI among the at least one multicast sub-codebook.

The size(s) of at least one multicast sub-codebook for the at least one multicast service may be generated based on DAI #1 and DAI #2. For example, the UE may determine the largest sub-codebook size and the second largest sub-codebook size for the at least one multicast service based on DAI #1 and DAI #2, respectively. The UE may generate the HARQ-ACK sub-codebooks for the at least one multicast service based on the largest sub-codebook size and the second largest sub-codebook size.

For example, when the number of generated HARQ-ACK information bits for a multicast service (prior to padding) is smaller than the second largest sub-codebook size, a padding bit(s) (e.g., NACK bit(s)) may be added (e.g., appended) to the HARQ-ACK sub-codebook for the multicast service to align with the second largest sub-codebook size. When the number of generated HARQ-ACK information bits for a multicast service (prior to padding) is larger than the second largest sub-codebook size and smaller than the largest sub-codebook size, a padding bit(s) (e.g., NACK bit(s)) may be added (e.g., appended) to the HARQ-ACK sub-codebook for the multicast service to align with the largest sub-codebook size.

For example, DAI #1 may correspond to the HARQ-ACK sub-codebook with the smallest sub-codebook size among the HARQ-ACK sub-codebooks for the at least one multicast service, and DAI #2 may correspond to the HARQ-ACK sub-codebook with the second smallest sub-codebook size among the HARQ-ACK sub-codebooks for the at least one multicast service. As an alternative, DAI #1 may correspond to the second smallest multicast sub-codebook size and DAI #2 may correspond to the smallest multicast sub-codebook size.

For instance, DAI #1 may indicate the minimum number of {serving cell, PDCCH monitoring occasion}-pair(s) in which PDSCH transmission(s) associated with PDCCH or PDCCH indicating SPS PDSCH release is present among the at least one multicast service. For example, DAI #1 may indicate the smallest DL DAI among the at least one multicast sub-codebook. DAI #2 may indicate the second smallest number of {serving cell, PDCCH monitoring occasion}-pair(s) in which PDSCH transmission(s) associated with PDCCH or PDCCH indicating SPS PDSCH release is present among the at least one multicast service. For example, DAI #2 may indicate the second smallest DL DAI among the at least one multicast sub-codebook. As an alternative, DAI #1 may indicate the second smallest DL DAI among the at least one multicast sub-codebook and DAI #2 may indicate the smallest DL DAI among the at least one multicast sub-codebook.

The size(s) of at least one multicast sub-codebook for the at least one multicast service may be generated based on DAI #1 and DAI #2. For example, the UE may determine the smallest sub-codebook size and the second smallest sub-codebook size for the at least one multicast service based on DAI #1 and DAI #2, respectively. The UE may generate the HARQ-ACK sub-codebooks for the at least one multicast service based on the smallest sub-codebook size and the second smallest sub-codebook size.

For example, when the number of generated HARQ-ACK information bits for a multicast service (prior to padding) is smaller than the smallest sub-codebook size, a padding bit(s) (e.g., NACK bit(s)) may be added (e.g., appended) to the HARQ-ACK sub-codebook for the multicast service to align with the smallest sub-codebook size. When the number of generated HARQ-ACK information bits for a multicast service (prior to padding) is larger than the smallest sub-codebook size and smaller than the second smallest sub-codebook size, a padding bit(s) (e.g., NACK bit(s)) may be added (e.g., appended) to the HARQ-ACK sub-codebook for the multicast service to align with the second smallest sub-codebook size.

For example, referring back to FIG. 2, in which no HARQ-ACK feedback for unicast PDSCHs is to be multiplexed with HARQ-ACK feedback for multicast PDSCHs of two multicast service on the same PUSCH, DCI format 221 may include two UL DAIs (e.g., DAI #1B′ and DAI #2B′).

DAI #1B′ may indicate 2 since there are a minimum of two multicast PDSCHS (e.g., PDSCHs #5 and #6) of a multicast service with corresponding HARQ-ACK feedback to be multiplexed on PUSCH 231. DAI #2B′ may indicate 4 since there are a second smallest of four multicast PDSCHS (e.g., PDSCHs #1-#4) of a multicast service with corresponding HARQ-ACK feedback to be multiplexed on PUSCH 231. The UE may generate the HARQ-ACK sub-codebook #1A and HARQ-ACK sub-codebook #2A based on the values of DAI #1B′ and DAI #2B′.

When the at least one multicast service includes only one multicast service, that is, only one multicast service has HARQ-ACK feedback to be multiplexed on the scheduled PUSCH, one of DAI #1 and DAI #2 may correspond to this multicast service and the other one may be reserved.

In some embodiments of the present disclosure, the UL DAI field in the DCI format scheduling the PUSCH is only used for unicast PDSCHs. The DCI format further includes an indicator indicating to the UE whether to multiplex HARQ-ACK feedback for a multicast service on the scheduled PUSCH.

For example, the indicator may include one bit. Bit “0” may indicate not to multiplex HARQ-ACK feedback for a multicast service on the scheduled PUSCH, and bit “1” may indicate to multiplex HARQ-ACK feedback for a multicast service on the scheduled PUSCH; or vice versa.

In response to the reception of the indicator in the DCI format, when the indicator indicates to multiplex HARQ-ACK feedback for a multicast service on the scheduled PUSCH, the UE may determine a HARQ-ACK sub-codebook size for each multicast service with HARQ-ACK feedback to be multiplexed on the PUSCH according to various methods, for example, Options 1-3 as described above.

In response to the reception of the indicator in the DCI format, when the indicator indicates not to multiplex HARQ-ACK feedback for a multicast service on the scheduled PUSCH, the UE may not multiplex the HARQ-ACK feedback for any multicast service on the scheduled PUSCH. For example, the UE may transmit the PUCCH or the PUSCH with the higher priority and may drop the one with the lower priority. For example, when the PUCCH has a higher priority than the PUSCH, the UE may transmit the HARQ-ACK feedback on the PUCCH and drop the PUSCH. When the PUSCH has a higher priority than the PUCCH, the UE may transmit the PUSCH and drop the PUCCH.

In some embodiments of the present disclosure, the UL DAI field in the DCI format scheduling the PUSCH is only used for unicast PDSCHs. When the HARQ-ACK feedback for unicast PDSCHs and the HARQ-ACK feedback for multicast PDSCHs carrying at least one multicast service are to be multiplexed on a PUSCH, separate coding (e.g., encoding at the UE side and decoding at the BS side) may be performed for the HARQ-ACK information bits for the unicast PDSCHs independently from the HARQ-ACK information bits for the multicast PDSCHs for the at least one multicast service.

For example, during the rate matching procedure for HARQ-ACK feedback on a PUSCH, HARQ-ACK information bits for unicast PDSCHs are mapped firstly then followed by HARQ-ACK information bits for multicast PDSCHs for the at least one multicast service.

For example, in response to the reception of the UL DAI in the DCI format scheduling the PUSCH, the UE may generate a HARQ-ACK sub-codebook for the unicast PDSCHs and at least one HARQ-ACK sub-codebook for the at least one multicast service. Then, the UE may encode the unicast HARQ-ACK sub-codebook separately from encoding the at least one multicast HARQ-ACK sub-codebooks. HARQ-ACK sub-codebook size for each of the at least one multicast HARQ-ACK sub-codebooks may be determined according to various methods, for example, Options 1-3 as described above.

FIG. 4 illustrates a flow chart of an exemplary procedure 400 for wireless communications in accordance with some embodiments of the present disclosure. Details described in all of the foregoing embodiments of the present disclosure are applicable for the embodiments shown in FIG. 4. In some examples, the procedure may be performed by a UE, for example, UE 101 in FIG. 1.

Referring to FIG. 4, in operation 411, a UE may receive a first set of PDSCHs associated with a first service and a second set of group-common PDSCHs associated with a second service, wherein the second service may be a multicast service.

In operation 413, the UE may receive a DCI format scheduling a PUSCH, wherein the DCI format may include a first DAI associated with HARQ-ACK feedback to be multiplexed on the PUSCH. In operation 415, the UE may generate a HARQ-ACK codebook including a first HARQ-ACK sub-codebook for the first set of PDSCHs and a second HARQ-ACK sub-codebook for the second set of PDSCHs. In operation 417, the UE may multiplex the HARQ-ACK codebook on the PUSCH.

In some examples, the first set of PDSCHs may be UE-specific PDSCHs and the first service may be a unicast service. In some examples, the first set of PDSCHs may be group-common PDSCHs and the first service may be a multicast service. The first service may be associated with a first RNTI and the second service is associated with a second RNTI. The value of the first RNTI may be smaller than the value of the second RNTI.

In some embodiments of the present disclosure, the first DAI may correspond to the first HARQ-ACK sub-codebook. The first HARQ-ACK sub-codebook may be placed in front of the second HARQ-ACK sub-codebook in the HARQ-ACK codebook.

In some examples, the size of the second HARQ-ACK sub-codebook may be configured by RRC signaling or predefined. In some examples, the size of the second HARQ-ACK sub-codebook may be determined based on the first DAI.

In some examples, the size of the second HARQ-ACK sub-codebook may be determined based on a set of candidate HARQ-ACK sub-codebook sizes. The set of candidate HARQ-ACK sub-codebook sizes may be configured by RRC signaling or predefined.

In some examples, determining the size of the second HARQ-ACK sub-codebook based on the set of candidate HARQ-ACK sub-codebook sizes may include: determining a sub-codebook size based on the second set of PDSCHs; and selecting, from the set of candidate HARQ-ACK sub-codebook sizes, a minimum value which is equal to or greater than the sub-codebook size as the size of the second HARQ-ACK sub-codebook.

In some examples, the UE may add a padding bit(s) to the second HARQ-ACK sub-codebook until the size of the second HARQ-ACK sub-codebook is equal to the determined size of the second HARQ-ACK sub-codebook.

In some examples, the UE may perform HARQ-ACK bundling among HARQ-ACK information bits for the second set of PDSCHs to generate the second HARQ-ACK sub-codebook. For example, to perform the HARQ-ACK bundling, the processor is configured to perform one of the following: bundling the HARQ-ACK information bits according to a predetermined bundling size; or bundling the HARQ-ACK information bits into a predetermined number of bits.

In some embodiments of the present disclosure, the DCI format may include a second DAI associated with HARQ-ACK feedback to be multiplexed on the PUSCH.

In some examples, the first DAI may correspond to the first HARQ-ACK sub-codebook for the first service and the first service may be a unicast service. The second DAI may correspond to the second HARQ-ACK sub-codebook for the second service. The second service may be with the largest or smallest HARQ-ACK sub-codebook size among at least one multicast service with HARQ-ACK feedback to be multiplexed on the PUSCH. For example, the second DAI may indicate the largest or smallest downlink DAI among the HARQ-ACK sub-codebooks for the at least one multicast service.

In some examples, the first DAI may correspond to the first HARQ-ACK sub-codebook for the first service. The first service may be a multicast service with the largest HARQ-ACK sub-codebook size among at least one multicast service with HARQ-ACK feedback to be multiplexed on the PUSCH. The second DAI may correspond to the second HARQ-ACK sub-codebook for the second service. The second service may be a multicast service with the smallest HARQ-ACK sub-codebook size among the at least one multicast service. For example, the first DAI may indicate the largest downlink DAI among the HARQ-ACK sub-codebooks for the at least one multicast service and the second DAI may indicate the smallest downlink DAI among the HARQ-ACK sub-codebooks for the at least one multicast service.

In some examples, the first DAI may correspond to the first HARQ-ACK sub-codebook for the first service. The first service may be a multicast service with the largest HARQ-ACK sub-codebook size among the at least one multicast service. The second DAI may correspond to the second HARQ-ACK sub-codebook for the second service. The second service may be a multicast service with the second largest HARQ-ACK sub-codebook size among the at least one multicast service. For example, the first DAI may indicate the largest downlink DAI among the HARQ-ACK sub-codebooks for the at least one multicast service and the second DAI may indicate the second largest downlink DAI among the HARQ-ACK sub-codebooks for the at least one multicast service.

In some examples, the first DAI may correspond to the first HARQ-ACK sub-codebook for the first service. The first service may be a multicast service with the smallest HARQ-ACK sub-codebook size among the at least one multicast service. The second DAI may correspond to the second HARQ-ACK sub-codebook for the second service. The second service may be a multicast service with the second smallest HARQ-ACK sub-codebook size among the at least one multicast service. For example, the first DAI may indicate the smallest downlink DAI among the HARQ-ACK sub-codebooks for the at least one multicast service and the second DAI may indicate the second smallest downlink DAI among the HARQ-ACK sub-codebooks for the at least one multicast service.

In some embodiments of the present disclosure, the DCI format may further include an indicator indicating whether to multiplex HARQ-ACK feedback for a multicast service on the PUSCH. The UE may multiplex HARQ-ACK feedback for a multicast service on the PUSCH in response to the indicator in the DCI format indicating multiplexing HARQ-ACK feedback for a multicast service on the PUSCH.

In some embodiments of the present disclosure, the UE may encode the first HARQ-ACK sub-codebook separately from the second HARQ-ACK sub-codebook.

It should be appreciated by persons skilled in the art that the sequence of the operations in exemplary procedure 400 may be changed and some of the operations in exemplary procedure 400 may be eliminated or modified, without departing from the spirit and scope of the disclosure.

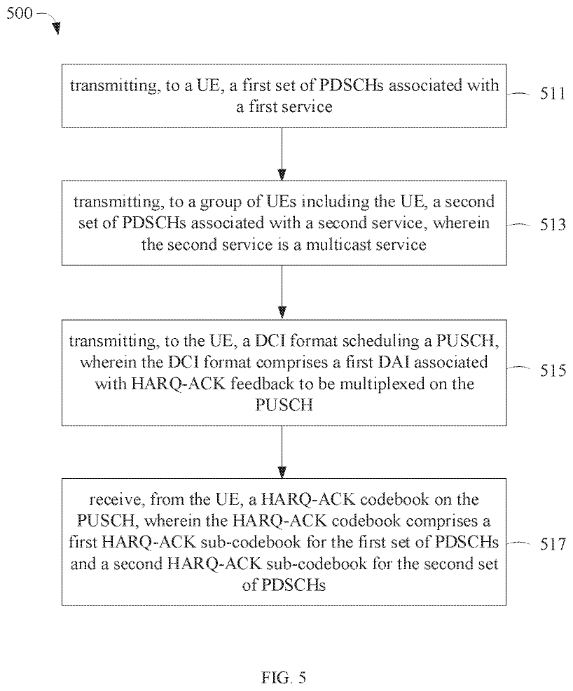

FIG. 5 illustrates a flow chart of an exemplary procedure 500 for wireless communications in accordance with some embodiments of the present disclosure. Details described in all of the foregoing embodiments of the present disclosure are applicable for the embodiments shown in FIG. 5. In some examples, the procedure may be performed by a BS, for example, BS 102 in FIG. 1.

Referring to FIG. 5, in operation 511, a BS may transmit, to a UE, a first set of PDSCHs associated with a first service. In operation 513, the BS may transmit, to a group of UEs including the UE, a second set of PDSCHs associated with a second service, wherein the second service is a multicast service. In operation 515, the BS may transmit, to the UE, a DCI format scheduling a PUSCH, wherein the DCI format comprises a first DAI associated with HARQ-ACK feedback to be multiplexed on the PUSCH.

In operation 517, the BS may receive, from the UE, a HARQ-ACK codebook on the PUSCH, wherein the HARQ-ACK codebook comprises a first HARQ-ACK sub-codebook for the first set of PDSCHs and a second HARQ-ACK sub-codebook for the second set of PDSCHs.

In some examples, the first set of PDSCHs may be UE-specific PDSCHs and the first service may be a unicast service. In some examples, the first set of PDSCHs may be group-common PDSCHs and the first service may be a multicast service. The first service may be associated with a first RNTI and the second service is associated with a second RNTI. The value of the first RNTI may be smaller than the value of the second RNTI.

In some embodiments of the present disclosure, the first DAI may correspond to the first HARQ-ACK sub-codebook. The first HARQ-ACK sub-codebook may be placed in front of the second HARQ-ACK sub-codebook in the HARQ-ACK codebook.

In some examples, the size of the second HARQ-ACK sub-codebook may be configured by the BS via RRC signaling or predefined. In some examples, the second HARQ-ACK sub-codebook may be generated by performing a HARQ-ACK bundling operation among HARQ-ACK information bits for the second set of PDSCHs. In some examples, the size of the second HARQ-ACK sub-codebook may be determined based on the first DAI.

In some examples, the BS may determine the size of the second HARQ-ACK sub-codebook based on a set of candidate HARQ-ACK sub-codebook sizes. The set of candidate HARQ-ACK sub-codebook sizes may be configured by the BS via radio resource control (RRC) signaling or predefined. In some examples, determining the size of the second HARQ-ACK sub-codebook based on the set of candidate HARQ-ACK sub-codebook sizes may include: determining a sub-codebook size based on the second set of PDSCHs; and selecting, from the set of candidate HARQ-ACK sub-codebook sizes, a minimum value which is equal to or greater than the sub-codebook size as the size of the second HARQ-ACK sub-codebook.

In some embodiments of the present disclosure, the DCI format may include a second DAI associated with HARQ-ACK feedback to be multiplexed on the PUSCH.

In some examples, the first DAI may correspond to the first HARQ-ACK sub-codebook for the first service and the first service may be a unicast service. The second DAI may correspond to the second HARQ-ACK sub-codebook for the second service. The second service may be with the largest or smallest HARQ-ACK sub-codebook size among at least one multicast service with HARQ-ACK feedback to be multiplexed on the PUSCH. For example, the second DAI may indicate the largest or smallest downlink DAI among the HARQ-ACK sub-codebooks for the at least one multicast service.

In some examples, the first DAI may correspond to the first HARQ-ACK sub-codebook for the first service. The first service may be a multicast service with the largest HARQ-ACK sub-codebook size among at least one multicast service with HARQ-ACK feedback to be multiplexed on the PUSCH. The second DAI may correspond to the second HARQ-ACK sub-codebook for the second service. The second service may be a multicast service with the smallest HARQ-ACK sub-codebook size among the at least one multicast service. For example, the first DAI may indicate the largest downlink DAI among the HARQ-ACK sub-codebooks for the at least one multicast service and the second DAI may indicate the smallest downlink DAI among the HARQ-ACK sub-codebooks for the at least one multicast service.

In some examples, the first DAI may correspond to the first HARQ-ACK sub-codebook for the first service. The first service may be a multicast service with the largest HARQ-ACK sub-codebook size among the at least one multicast service. The second DAI may correspond to the second HARQ-ACK sub-codebook for the second service. The second service may be a multicast service with the second largest HARQ-ACK sub-codebook size among the at least one multicast service. For example, the first DAI may indicate the largest downlink DAI among the HARQ-ACK sub-codebooks for the at least one multicast service and the second DAI may indicate the second largest downlink DAI among the HARQ-ACK sub-codebooks for the at least one multicast service.

In some examples, the first DAI may correspond to the first HARQ-ACK sub-codebook for the first service. The first service may be a multicast service with the smallest HARQ-ACK sub-codebook size among the at least one multicast service. The second DAI may correspond to the second HARQ-ACK sub-codebook for the second service. The second service may be a multicast service with the second smallest HARQ-ACK sub-codebook size among the at least one multicast service. For example, the first DAI may indicate the smallest downlink DAI among the HARQ-ACK sub-codebooks for the at least one multicast service and the second DAI may indicate the second smallest downlink DAI among the HARQ-ACK sub-codebooks for the at least one multicast service.

In some embodiments of the present disclosure, the DCI format may further include an indicator indicating whether to multiplex HARQ-ACK feedback for a multicast service on the PUSCH. The BS may receive HARQ-ACK feedback for a multicast service on the PUSCH in response to the indicator in the DCI format indicating multiplexing HARQ-ACK feedback for a multicast service on the PUSCH.

In some embodiments of the present disclosure, the BS may decode the first HARQ-ACK sub-codebook separately from the second HARQ-ACK sub-codebook.

It should be appreciated by persons skilled in the art that the sequence of the operations in exemplary procedure 500 may be changed and some of the operations in exemplary procedure 500 may be eliminated or modified, without departing from the spirit and scope of the disclosure.

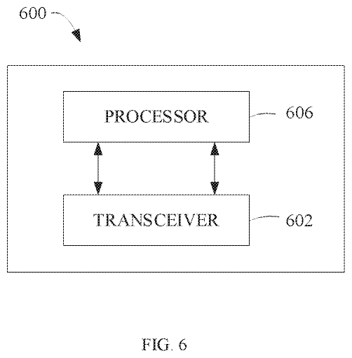

FIG. 6 illustrates a block diagram of an exemplary apparatus 600 according to some embodiments of the present disclosure. As shown in FIG. 6, the apparatus 600 may include at least one processor 606 and at least one transceiver 602 coupled to the processor 606. The apparatus 600 may be a UE or a BS.

Although in this figure, elements such as the at least one transceiver 602 and processor 606 are described in the singular, the plural is contemplated unless a limitation to the singular is explicitly stated. In some embodiments of the present application, the transceiver 602 may be divided into two devices, such as a receiving circuitry and a transmitting circuitry. In some embodiments of the present application, the apparatus 600 may further include an input device, a memory, and/or other components.

In some embodiments of the present application, the apparatus 600 may be a UE. The transceiver 602 and the processor 606 may interact with each other so as to perform the operations with respect to the UE described in FIGS. 1-5. In some embodiments of the present application, the apparatus 600 may be a BS. The transceiver 602 and the processor 606 may interact with each other so as to perform the operations with respect to the BS described in FIGS. 1-5.

In some embodiments of the present application, the apparatus 600 may further include at least one non-transitory computer-readable medium.

For example, in some embodiments of the present disclosure, the non-transitory computer-readable medium may have stored thereon computer-executable instructions to cause the processor 606 to implement the method with respect to the UE as described above. For example, the computer-executable instructions, when executed, cause the processor 606 interacting with transceiver 602, so as to perform the operations with respect to the UE described in FIGS. 1-5.

In some embodiments of the present disclosure, the non-transitory computer-readable medium may have stored thereon computer-executable instructions to cause the processor 606 to implement the method with respect to the BS as described above. For example, the computer-executable instructions, when executed, cause the processor 606 interacting with transceiver 602 to perform the operations with respect to the BS described in FIGS. 1-5.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
receive a first set of physical downlink shared channels (PDSCHs) associated with a first service and a second set of group-common PDSCHs associated with a second service, wherein the second service is a multicast service;
receive a downlink control information (DCI) format scheduling a physical uplink shared channel (PUSCH), wherein the DCI format comprises a first downlink assignment index (DAI) associated with hybrid automatic repeat request acknowledgement (HARQ-ACK) feedback to be multiplexed on the PUSCH;
generate a HARQ-ACK codebook comprising a first HARQ-ACK sub-codebook for the first set of PDSCHs and a second HARQ-ACK sub-codebook for the second set of PDSCHs; and
multiplex the HARQ-ACK codebook on the PUSCH.

2. The UE of claim 1, wherein the first DAI corresponds to the first HARQ-ACK sub-codebook, and wherein the first HARQ-ACK sub-codebook is placed in front of the second HARQ-ACK sub-codebook in the HARQ-ACK codebook.

3. The UE of claim 1, wherein the first set of PDSCHs are UE-specific PDSCHs and the first service is a unicast service.

4. The UE of claim 1, wherein the first set of PDSCHs are group-common PDSCHs and the first service is a multicast service; and
wherein the first service is associated with a first radio network temporary identifier (RNTI) and the second service is associated with a second RNTI and a value of the first RNTI is smaller than a value of the second RNTI.

5. The UE of claim 2, wherein a size of the second HARQ-ACK sub-codebook is configured by radio resource control (RRC) signaling or predefined; or
wherein the size of the second HARQ-ACK sub-codebook is determined based on a set of candidate HARQ-ACK sub-codebook sizes; or
wherein the size of the second HARQ-ACK sub-codebook is determined based on the first DAI.

6. The UE of claim 5, wherein determining the size of the second HARQ-ACK sub-codebook based on the set of candidate HARQ-ACK sub-codebook sizes comprises:
determining a sub-codebook size based on the second set of PDSCHs; and
selecting, from the set of candidate HARQ-ACK sub-codebook sizes, a minimum value which is equal to or greater than the sub-codebook size as the size of the second HARQ-ACK sub-codebook.

7. The UE of claim 2, wherein the at least one processor is configured to cause the UE to perform HARQ-ACK bundling among HARQ-ACK information bits for the second set of PDSCHs to generate the second HARQ-ACK sub-codebook.

8. The UE of claim 7, wherein to perform the HARQ-ACK bundling, the at least one processor is configured to cause the UE to perform one of the following:
bundling the HARQ-ACK information bits according to a predetermined bundling size; or
bundling the HARQ-ACK information bits into a predetermined number of bits.

9. The UE of claim 1, wherein the DCI format comprises a second DAI associated with HARQ-ACK feedback to be multiplexed on the PUSCH.

10. The UE of claim 9, wherein the first DAI corresponds to the first HARQ-ACK sub-codebook for the first service and the first service is a unicast service, and the second DAI corresponds to the second HARQ-ACK sub-codebook for the second service and the second service is with the largest or smallest HARQ-ACK sub-codebook size among at least one multicast service with HARQ-ACK feedback to be multiplexed on the PUSCH; or
wherein the first DAI corresponds to the first HARQ-ACK sub-codebook for the first service and the first service is a multicast service with the largest HARQ-ACK sub-codebook size among at least one multicast service with HARQ-ACK feedback to be multiplexed on the PUSCH, and the second DAI corresponds to the second HARQ-ACK sub-codebook for the second service and the second service is a multicast service with the smallest HARQ-ACK sub-codebook size among the at least one multicast service; or
wherein the first DAI corresponds to the first HARQ-ACK sub-codebook for the first service and the first service is a multicast service with the largest HARQ-ACK sub-codebook size among the at least one multicast service, and the second DAI corresponds to the second HARQ-ACK sub-codebook for the second service and the second service is a multicast service with a second largest HARQ-ACK sub-codebook size among the at least one multicast service; or
wherein the first DAI corresponds to the first HARQ-ACK sub-codebook for the first service and the first service is a multicast service with the smallest HARQ-ACK sub-codebook size among the at least one multicast service and the second DAI corresponds to the second HARQ-ACK sub-codebook for the second service and the second service is a multicast service with a second smallest HARQ-ACK sub-codebook size among the at least one multicast service.

11. The UE of claim 10, wherein the second DAI indicates the largest or smallest downlink DAI among the HARQ-ACK sub-codebooks for the at least one multicast service; or
wherein the first DAI indicates the largest downlink DAI among the HARQ-ACK sub-codebooks for the at least one multicast service and the second DAI indicates the smallest downlink DAI among the HARQ-ACK sub-codebooks for the at least one multicast service; or
wherein the first DAI indicates the largest downlink DAI among the HARQ-ACK sub-codebooks for the at least one multicast service and the second DAI indicates the second largest downlink DAI among the HARQ-ACK sub-codebooks for the at least one multicast service; or
wherein the first DAI indicates the smallest downlink DAI among the HARQ-ACK sub-codebooks for the at least one multicast service and the second DAI indicates the second smallest downlink DAI among the HARQ-ACK sub-codebooks for the at least one multicast service.

12. The UE of claim 1, wherein the DCI format further comprises an indicator indicating whether to multiplex HARQ-ACK feedback for a multicast service on the PUSCH.

13. The UE of claim 3, wherein the at least one processor is configured to cause the UE to encode the first HARQ-ACK sub-codebook separately from the second HARQ-ACK sub-codebook.

14. A base station (BS), comprising:
at least one memory; and
at least one processor coupled with the at least one memory and configured to cause the base station to:
transmit, to a user equipment (UE), a first set of physical downlink shared channels (PDSCHs) associated with a first service;
transmit, to a group of UEs including the UE, a second set of PDSCHs associated with a second service, wherein the second service is a multicast service;
transmit, to the UE, a downlink control information (DCI) format scheduling a physical uplink shared channel (PUSCH), wherein the DCI format comprises a first downlink assignment index (DAI) associated with hybrid automatic repeat request acknowledgement (HARQ-ACK) feedback to be multiplexed on the PUSCH;
receive, from the UE, a HARQ-ACK codebook on the PUSCH, wherein the HARQ-ACK codebook comprises a first HARQ-ACK sub-codebook for the first set of PDSCHs and a second HARQ-ACK sub-codebook for the second set of PDSCHs.

15. A method performed by a user equipment (UE), the method comprising:
receiving a first set of physical downlink shared channels (PDSCHs) associated with a first service and a second set of group-common PDSCHs associated with a second service, wherein the second service is a multicast service;
receiving a downlink control information (DCI) format scheduling a physical uplink shared channel (PUSCH), wherein the DCI format comprises a first downlink assignment index (DAI) associated with hybrid automatic repeat request acknowledgement (HARQ-ACK) feedback to be multiplexed on the PUSCH;
generating a HARQ-ACK codebook comprising a first HARQ-ACK sub-codebook for the first set of PDSCHs and a second HARQ-ACK sub-codebook for the second set of PDSCHs; and
multiplexing the HARQ-ACK codebook on the PUSCH.

16. A processor for wireless communication, comprising:
at least one controller coupled with at least one memory and configured to cause the processor to:
receive a first set of physical downlink shared channels (PDSCHs) associated with a first service and a second set of group-common PDSCHs associated with a second service, wherein the second service is a multicast service;
receive a downlink control information (DCI) format scheduling a physical uplink shared channel (PUSCH), wherein the DCI format comprises a first downlink assignment index (DAI) associated with hybrid automatic repeat request acknowledgement (HARQ-ACK) feedback to be multiplexed on the PUSCH;
generate a HARQ-ACK codebook comprising a first HARQ-ACK sub-codebook for the first set of PDSCHs and a second HARQ-ACK sub-codebook for the second set of PDSCHs; and
multiplex the HARQ-ACK codebook on the PUSCH.

17. The processor of claim 16, wherein the first DAI corresponds to the first HARQ-ACK sub-codebook, and wherein the first HARQ-ACK sub-codebook is placed in front of the second HARQ-ACK sub-codebook in the HARQ-ACK codebook.

18. The processor of claim 16, wherein the first set of PDSCHs are UE-specific PDSCHs and the first service is a unicast service.

19. The processor of claim 16, wherein the first set of PDSCHs are group-common PDSCHs and the first service is a multicast service; and
wherein the first service is associated with a first radio network temporary identifier (RNTI) and the second service is associated with a second RNTI and a value of the first RNTI is smaller than a value of the second RNTI.

20. The processor of claim 17, wherein a size of the second HARQ-ACK sub-codebook is configured by radio resource control (RRC) signaling or predefined; or
wherein the size of the second HARQ-ACK sub-codebook is determined based on a set of candidate HARQ-ACK sub-codebook sizes; or
wherein the size of the second HARQ-ACK sub-codebook is determined based on the first DAI.
